(19) United States
(12) Patent Application Publication
(10) Pub. No.: US 2016/0095781 A1
(43) Pub. Date: Apr. 7, 2016

(54) TISSUE MASSAGE DEVICE AND METHOD

(71) Applicant: Jeremy Hudson, Boston, MA (US)

(72) Inventor: Jeremy Hudson, Boston, MA (US)

(21) Appl. No.: 14/505,081

(22) Filed: Oct. 2, 2014

(51) Int. Cl. A61H 1/00

(52) U.S. Cl. CPC A61H 1/008

(57) ABSTRACT

In one embodiment of the tissue massage devices and methods described herein, a tissue massage device can include a base configured to be grasped in a user's hand such that a first surface at a proximal end of the device abuts against the user's palm. The device can also include a massage head extending from a second surface of the base that is distal to the first surface, the massage head having a generally convex shape and including a textured non-slip surface formed on a distal portion thereof. The textured non-slip surface can prevent sliding motion between the device and a user's skin, thereby causing sliding between subcutaneous fascia and muscle that is therapeutic.

### FIELD

The present invention relates to tissue massage and, more particularly, to a device and method for performing tissue massage.

### BACKGROUND

Physical activity that involves repetitive motion, prolonged and sustained posturing, high resistance, and/or trauma can cause inflammation of soft tissue in the body. The body responds to such inflammation by forming fibrous adhesions (essentially scar tissue) as a by-product of the healing process. The formation of adhesions is also accompanied by a neurological reaction known as a gamma motor response, which is essentially a localized spasm (inhibition) that effects all points controlling movement in a particular direction. Adhesions can form in any soft tissue of the body, including muscles, tendons, and ligaments, as well as in the areas between the muscle and connective tissue known as the fascia. Adhesions in the myofascial tissue (a layer of loose but strong connective tissue often containing fat that envelops all muscles and muscle fibers) can be painful, restrictive, and can inhibit force production from the muscle.

For example, pain associated with the neurologic reaction that occurs with adhesions can result in an instinctual adaptation of physical activity and/or an avoidance of beneficial behaviors in order to reduce the pain sensation. This phenomenon can drive people to lose productivity, seek expensive medical advice and treatment, and engage in masking behaviors that can be detrimental and may perpetuate the problem (e.g., changes in posture, body mechanics, etc.). To date, adhesions and the associated sensations of pain have been addressed with various combinations of drugs, surgical procedures, massage, foam rolling, exercise, stretching, hot/cold packs, electrical stimulation, ultrasound energy, and laser light.

None of these measures, however, address the mechanism of the adhesions and, as a result, are not ideal or particularly effective solutions. For example, research has shown that the pain, loss of range of motion, loss of strength, and other symptoms associated with adhesions are induced by a lack of sliding motion at the interface between the muscle and subcutaneous fat that make up the fascia. Conventional techniques for massage and other treatments do not effectively target this subcutaneous interface and therefore fail to eliminate the problem that causes the symptoms. One reason that conventional massage techniques fail is that they typically involve oils, lotions, creams, or ointments that allow for sliding motion between a massage tool (e.g., a hand, ball, or other implement) and the skin surface of the patient.

Moreover, research has identified over 150 specific neurologically dense points on the human body where, if subcutaneous muscle/fascia sliding does not occur, pain and movement inhibition can result. See, for example, Stecco L., Fascial Manipulation for Musculoskeletal Pain, Piccin, 2004. Still further, each of these points can be correlated to a specific movement dysfunction. Elimination of adhesions at any of these points can decrease pain and increase strength and range of motion for the particular correlated movement.

Accordingly, there is a need for improved devices and methods to efficiently and effectively treat adhesions in the myofascial tissue.

### SUMMARY

The present invention addresses these and other needs by providing devices and methods that eliminate adhesions at the interface between muscle and fascia tissue. More particularly, the devices and methods described herein can be used to cause sliding motion between the muscle fibers and fascia, and that sliding motion can undo or eliminate any adhesion formed in the immediate area. The devices and methods described herein can effectively induce subcutaneous sliding by preventing sliding motion between the device and a patient's skin that typically occurs with known massage tools.

In one aspect, a tissue massage device can include a base configured to be grasped in a user's hand such that a first surface at a proximal end of the device abuts against the user's palm, as well as a massage head extending from a second surface of the base that is distal to the first surface. The massage head can have a generally convex shape and can include a textured non-slip surface formed on a distal portion thereof. The base can be easily grasped and manipulated by a user's hand while the massage head with non-slip surface can eliminate sliding movement at the skin surface to more effectively cause subcutaneous sliding between the muscle and fascia.

The devices and methods described herein can have a number of additional features and/or variations, all of which are within the scope of the present invention. For example, in some embodiments the first surface can include a suction cup configured to allow the device to be mounted on a surface with the massage head protruding from the surface. Mounting the device to a wall or other structure in a removable manner allows a user to place the device at an appropriate height and then position their body relative to the device to administer treatment.

In other embodiments, the first surface can include a second textured non-slip surface formed thereon and configured to prevent slipping between the device and the user's palm. The second textured non-slip surface can be the same or substantially similar to the textured non-slip surface on the massage head, and in some embodiments can extend over a portion of the first surface having a diameter equal or substantially similar to the diameter of the massage head.

In still other embodiments, the first surface can include at least one indentation formed therein and positioned to accommodate a portion of the user's hand. Such an indentation (or indentations) can provide better purchase for a user when manipulating the device by hand. A number of different configurations of the indentations are possible. For example, in some embodiments the at least one indentation can include four indentations of equal size configured to receive a user's fingers. In other embodiments, the at least one indentation can include two opposed indentations configured to receive the user's thenar and hypothenar eminances (i.e., the muscular protrusions of the palm below the thumb and little finger, respectively).

The massage devices described herein can be formed from a variety of different materials. For example, in some embodiments the device can be formed from any of silicone and foam rubber (e.g., high density foam rubber). In some embodiments, the material can be selected at least in part based on its density to create a device that can apply sufficient pressure to engage the deeper fascia layers. Alternatively, weight can be added to lighter materials or interior voids can be formed in heavier materials to produce a desired weight. By way of example, the tissue massage devices described herein can have a weight in a range of about 0.4 kg to about 1 kg.

In addition, the massage devices described herein can have a variety of different sizes. For example, the base of the device can have any of a variety of sizes configured to fit within a user's hand (e.g., larger versions can be produced for users with larger hands and vice versa). The massage head can have a variety of sizes as well, but in some embodiments can be sized to match a size of a neurologically dense portion of a patient's body (e.g., the 150 points described above that correspond with specific movement dysfunctions). In some embodiments, for example, a diameter of the massage head can be in a range of about 40 mm to about 70 mm. In certain embodiments, the diameter of the massage head can be about 60 mm.

In some embodiments, the textured non-slip surface of the massage head can be formed by roughening a surface portion of the massage head material (e.g., using an abrasive, etc.). In other embodiments, however, a separate material having a different surface roughness than the material used to form the massage head can be coupled to an outer surface of the massage head. In some embodiments, the textured non-slip surface of the massage head can include one or more surface features protruding from a surface of the massage head that can be configured to grip the skin surface of the patient. In certain embodiments, the textured non-slip surface can be a series of uniform or non-uniform protrusions, bumps, or humps having a diameter in a range of about 2 mm to about 10 mm. These protrusions can be similar to small pebbles and can create a surface that resists sliding motion when in contact with a patient's skin. Regardless of the particular configuration of the non-slip surface though, it can be configured to prevent sliding motion between the massage head (or massage device generally) and the skin surface of a patient.

In another aspect, a method for tissue massage is provided that includes positioning a tissue massage device over a portion of a user's body such that a massage head of the device having a textured non-slip surface contacts the user's skin, and applying pressure to the tissue massage device such that the massage head does not slide on the user's skin and causes sliding between subcutaneous fascia and muscle.

As with the devices described herein, methods for tissue massage can include any number of variations and/or additional steps that are considered within the scope of the present invention. For example, in some embodiments positioning the tissue massage device can include removably mounting the tissue massage device to a surface and positioning the user's body relative to the device. This can be accomplished, for example, using a suction cup or other removable coupling mechanism, as described in more detail below. Still further, in certain embodiments applying pressure to the tissue massage device can be done by the user pressing their body into the device. For example, by leaning into a tissue massage device removably mounted to a wall or other structure.

In other embodiments, positioning the tissue massage device can be done by the user grasping the tissue massage device in their hand. Applying pressure to the tissue massage device can be done by the user's hand as well. As mentioned above, sliding motion between the user's hand and the device can be resisted by providing a second textured non-slip surface on the device that is configured to abut against the user's hand during use.

As mentioned above, elimination of adhesions at the interface between muscle and fascia can result in decreased pain, increased range of motion, and increase power output for a given movement. Accordingly, in some embodiments the method for tissue massage can further include testing a movement of the user's body for any of pain, range of motion, and strength prior to positioning the tissue massage device. Further, the method can include re-testing the movement of the user's body after applying pressure to the tissue massage device. Further, such an evaluation procedure can be designed to target specific movement dysfunctions based on, for example, the neurologically dense points on the human body described above.

Pressure applied to the tissue massage device can be maintained for a period of time to cause subcutaneous sliding motion and also to promote fluid flow throughout the immediate area, which can prevent the reformation of an adhesion. The period of time can be predetermined, or can be based upon a level of pain or other sensation experienced by a patient. For example, in some embodiments the pressure can be applied to the tissue massage device for a predetermined time. This time can, in some embodiments, be in a range of about 2 minutes to about 5 minutes. In other embodiments, however, the pressure can be applied to the tissue massage device until a user experiences a predetermined reduction in pain or another sensation. For example, the pressure can be applied until a patient experiences a 50% reduction in pain.

In still another aspect, a method for tissue massage is provided that includes positioning a tissue massage device having a generally convex massage head extending from a base configured to be grasped in a user's hand over a portion of a user's body such that a textured non-slip surface on a distal end portion of the massage head contacts the user's skin. The method can further include applying pressure to the base of the tissue massage device to drive the massage head into tissue such that the massage head does not slide on the user's skin and sliding motion is induced in subcutaneous tissue.

As noted above, any of the additional features or variations described herein can be applied to any particular aspect or embodiment of the invention in a number of different combinations; the absence of explicit recitation of any particular combination is due solely to the avoidance of repetition in this summary.

### BRIEF DESCRIPTION OF THE DRAWINGS

The aspects and embodiments of the invention described above will be more fully understood from the following detailed description taken in conjunction with the accompanying drawings, in which:

FIG. 1 is a side view of one embodiment of a tissue massage device;

FIG. 2 is a top view of the tissue massage device of FIG. 1;

FIG. 3 is a side view of an alternative embodiment of a tissue massage device;

FIG. 4 is a bottom view of one embodiment of a tissue massage device;

FIG. 5 is a bottom view of an alternative embodiment of a tissue massage device;

FIG. 6 is an illustration of the tissue massage device of FIG. 5 mounted to a structure; and

FIG. 7 is flowchart of one embodiment of a method of tissue massage.

### DETAILED DESCRIPTION

Certain exemplary embodiments will now be described to provide an overall understanding of the principles of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Additionally, to the extent that linear or circular dimensions are used in the description of the disclosed devices and methods, such dimensions are not intended to limit the types of shapes that can be used in conjunction with such devices and methods. A person skilled in the art will recognize that an equivalent to such linear and circular dimensions can easily be determined for any geometric shape. Further, in the present disclosure, like-numbered components of the embodiments generally have similar features. Still further, sizes and shapes of the devices, and the components thereof, can depend at least on the anatomy of the subject in which the devices will be used, the size and shape of components with which the devices will be used, and the methods and procedures in which the devices will be used.

The present invention is generally directed to devices and methods that treat myofascial adhesions by causing subcutaneous sliding movement between muscle fibers and the fascia that surround them. The absence of such sliding motion at this interface has been identified as causing pain, decreasing range of motion, and limiting muscle output. The elimination of adhesions at the interface of muscle and fascia can drastically decrease pain and improve muscle and/or joint performance. In order to cause the therapeutic subcutaneous sliding motion, the devices and methods described herein employ textured non-slip surfaces and application techniques that prevent undesired sliding motion between a device and a skin surface of the patient. This allows the pressure and movement of the device to target the subcutaneous tissue and produce dramatically improved results over conventional massage and other soft tissue treatment techniques.

The devices and methods described herein generally involve the application of pressure to a designated spot on a patient's body along with movement of the body and/or the device so as to force sliding movement at the subcutaneous interface between the muscle and fascia. This relative sliding motion can eliminate or undo any adhesions present in the immediate area, and also create localized warmth from friction that decreases the viscosity of hyaluronic acid and promotes fluid flow through the area. This latter effect of localized warming can be important because fluid flow helps to prevent the reoccurrence of adhesions. Undoing an adhesion and halting its associated neurological reaction can decrease pain and improve strength and range of motion. Use of the devices and methods described herein can therefore help prevent injury, enhance performance, and eliminate the need to pursue other expensive and generally ineffective remedies or treatments.

Further, the devices and methods described herein can include selecting a designated spot on a patient's body based on a movement dysfunction experienced by a user. For example, research has shown that there are over 150 points on the human body that are neurologically dense and each of these points can be associated with a specific movement dysfunction. See, for example, Stecco L., Fascial Manipulation for Musculoskeletal Pain, Piccin, 2004, the entire contents of which are hereby incorporated by reference as if they were reprinted here. Eliminating adhesions present in the myofascial tissue at these particular points can produce marked improvement in the correlated movement. Accordingly, the devices and methods described herein can include conducting a movement assessment to determine where pressure should be applied to provide the best results, and an iterative testing/massage procedure can be employed to continually improve a patient's strength and mobility.

In order to produce the subcutaneous sliding motion between the muscle and fascia, the devices and methods described herein can include features that prevent sliding motion between a massage device and a skin surface of the patient. Allowing a massage device to slide relative to the patient's skin can allow the subcutaneous tissues to remain stationary, thereby decreasing the effectiveness of the treatment. The non-rolling, dynamic, and deep pressure imparted by the devices and methods described herein instead causes the deeper fascia to slide over the outer layer of muscular tissue. This type of treatment is opposite conventional massage technique, which typically involves oils, lotions, creams, or ointments specifically intended to facilitate sliding motion of a massage device over the skin surface.

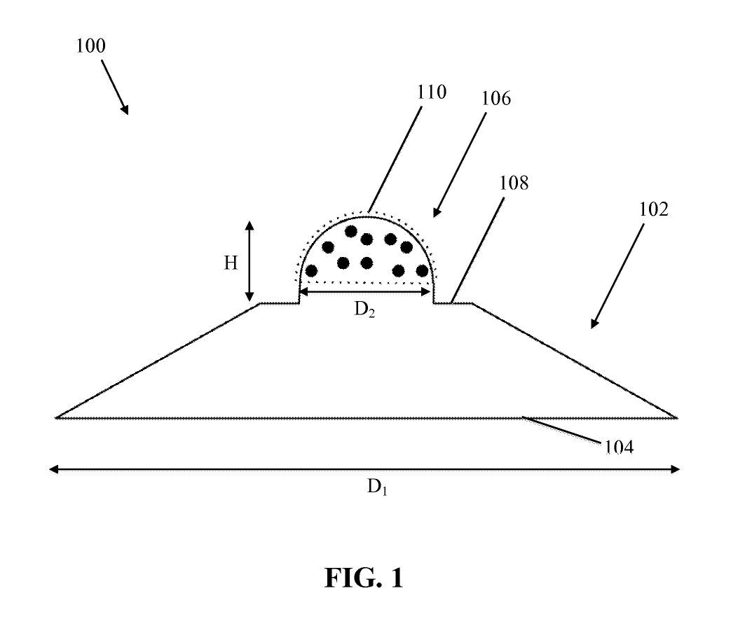

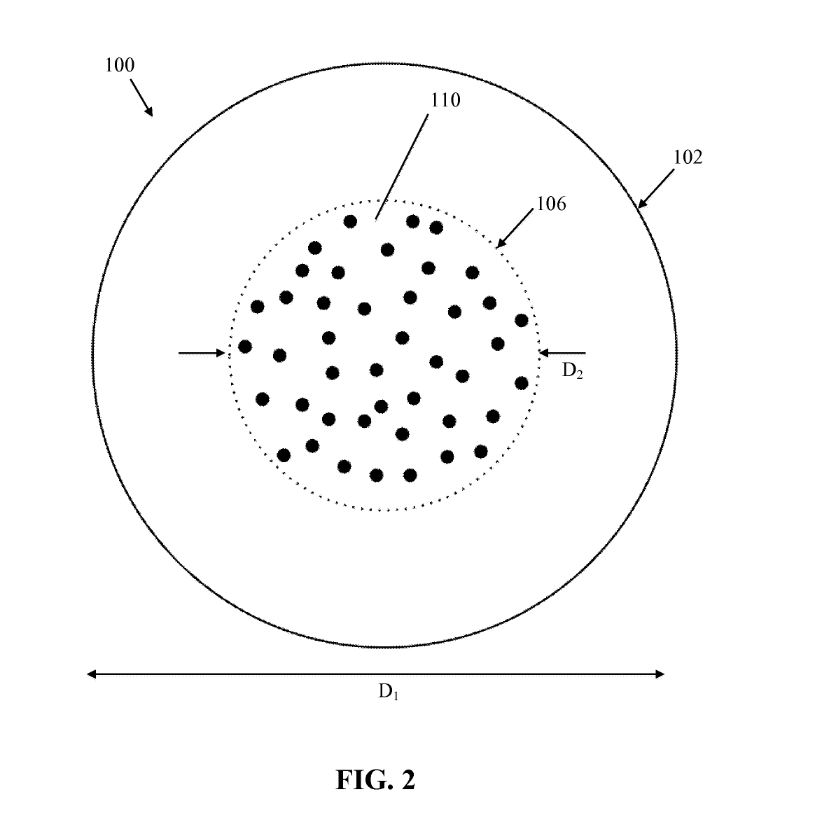

FIGS. 1 and 2 illustrate one embodiment of a tissue massage device 100. The device 100 includes a base 102 configured to be grasped in a user's hand such that a first surface 104 at a proximal end of the device abuts against the user's palm. The device further includes a massage head 106 extending from a second surface 108 of the base 102 that is distal to the first surface 104. The massage head 106 has a generally convex shape (e.g., a hemisphere as illustrated) and includes a textured non-slip surface 110 formed on a distal portion thereof.

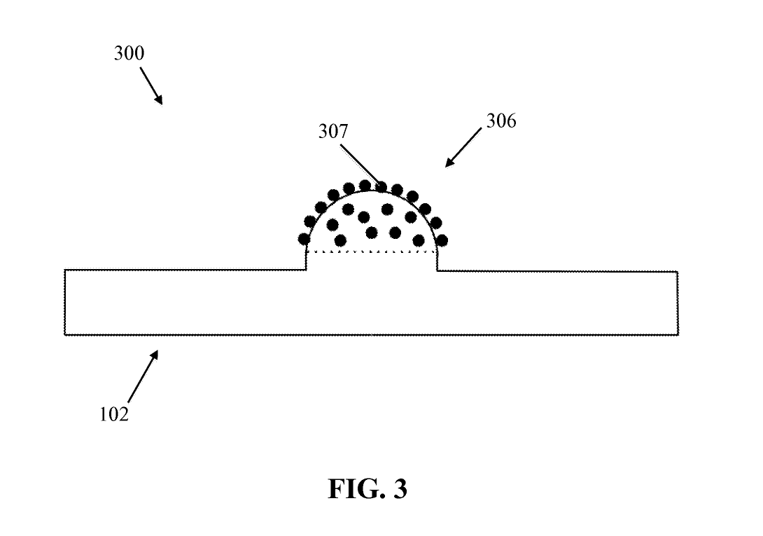

The base 102 can have any of a variety of shapes and sizes. In the illustrated embodiment, for example, the base has a generally conical shape having tapered sidewalls. Other shapes are possible, however, such as the cylindrical shape of the base 302 shown in FIG. 3, or other known shapes, such as squares, rectangles, triangles, etc. Further, the size of the base can be varied depending on the size of a user's hand, but in some embodiments the base can have a diameter that is roughly twice the diameter of the massage head 106. Such a configuration can allow pressure to be applied by a user with some lateral force without causing the device to tip over onto its side. For example, in some embodiments the base 102 can have an outer diameter D₁ that is in a range of about 90 mm to about 160 mm. Further, in certain embodiments, the outer diameter D₁ can be about 120 mm.

The massage head 106 can similarly have a variety of shapes and sizes. For example, the illustrated massage head 106 has a generally hemispherical shape that extends from the second surface 108. The size of the massage head 106 can be selected based on a size of any of the 150 neurologically dense points on the human body described above. Such observations can be based on cadaver research rather than theory and, as a result, can produce better targeting of these points and better therapy results. Further information can be found in Stecco L., Fascial Manipulation for Musculoskeletal Pain, Piccin, 2004, which is incorporated by reference in its entirety above. In view of such research, for example, a diameter D₂ of the massage head 106 can be in a range of about 40 mm to about 70 mm. By way of further example, in certain embodiments the diameter D₂ of the massage head 106 can be about 60 mm.

Further, the massage head 106 can have any of a variety of heights H extending from the second surface 108 of the base 102. In some embodiments, the height H of the massage head 106 can be in a range of about 70% to about 100% of the diameter of the massage head. Selecting a height H in this range can allow for the application of pressure with some lateral component without tipping the device over, similar to the rationale discussed above for selecting the diameter of the base 102 relative to the massage head 106.

The textured non-slip surface 110 of the massage head 106 can be configured to prevent sliding movement between a patient's skin and the device 100. The surface 110 can be formed in a variety of different manners. For example, in some embodiments the surface 110 can be formed by abrading or otherwise roughening the material of the massage head 106. In other embodiments, however, a thin layer of roughened material can be applied over the outer surface of the massage head 106. Such a distinct material can be coupled to an outer surface of the massage head 106 using any of a variety of techniques known in the art, including adhesives, mechanical fasteners, material welding, etc.

The textured non-slip surface 110 can have different and varying levels of roughness. In some embodiments, for example, the surface 110 can approximate the roughness of sandpaper or gravel. In some embodiments, surface features can be formed on an outer surface of the massage head 106 to provide a textured non-slip surface. FIG. 3 illustrates one example of such an embodiment that includes nodules 307 formed on an outer surface of the massage head 306 to provide a non-slip surface. The nodules 307 can be formed by cutting back material of the massage head 306, or by coupling nodules of a same or different material to an outer surface of the massage head. Exemplary mechanisms for coupling nodules 307 to the massage head 306 can include adhesives, mechanical fasteners, material welding, etc. In addition, the surfaces of the individual nodules 307 or other features can themselves include a roughened surface to aid in gripping a patient's skin.

Regardless of the techniques utilized to create the textured, non-slip surface 110, the surface can be configured to prevent sliding movement when in contact with a patient's skin. In some embodiments, this can be accomplished by providing on the surface 110 a series of uniform or non-uniform protrusions having a diameter in a range of about 2 mm to about 10 mm. These protrusions, humps, or bumps on the surface 110 can be similar to the size of small pebbles. The protrusions can extend from a surface of the massage head 106 by any distance up to their diameter. For example, protrusions that extend from the surface of the massage head 106 by greater than 50% of their diameter can more closely resemble the nodules shown in FIG. 3, while protrusions that extend from the surface of the massage head by less than 50% of their diameter can more closely resemble a smooth but undulating surface, as shown in FIG. 1.

The tissue massage device 100 can be formed from a single material, or a blend of multiple materials. For example, in some embodiments the tissue massage device 100 can be formed from silicone using, e.g., a molding process. Other materials are possible as well, however, including, for example, foam rubber (e.g., high density foam rubber), other elastic polymers, and even inelastic or rigid materials, such as rigid polymers, metals, etc. In some embodiments, the base 102 can be formed from one material, while the massage head 106 can be formed from another material. In such embodiments, the massage head 106 can be mated to the base 102 using any known coupling technique, such as adhesive fastening, mechanical fastening, material welding, etc.

A weight of the device 100 can be selected such that the combined weight of the device and a user's palm (or palms) is sufficient to apply pressure that can engage the deep fascia in contact with muscle below the surface of the skin. In some embodiments, the weight of the device 100 can be in a range of about 0.4 kg to about 1 kg. The material of the device 100 can be selected based on its density so as to achieve a desired weight or, in some embodiments, weight can be added or internal voids can be formed to adjust the weight of the device.

As mentioned above, the base 102 can be configured to be grasped in a user's hand such that the user can press the massage head 106 into their body by applying pressure to the first surface 104 with their palm. The base can have any of a variety of shapes and sizes to allow users of various sizes to effectively grasp and manipulate the device. In some embodiments, the base can include at least one feature formed thereon to aid users in securely grasping the device. In some embodiments, the at least one feature can be an indentation, groove, or depression formed in a sidewall and/or bottom surface of the base to accommodate a portion of a user's hand.

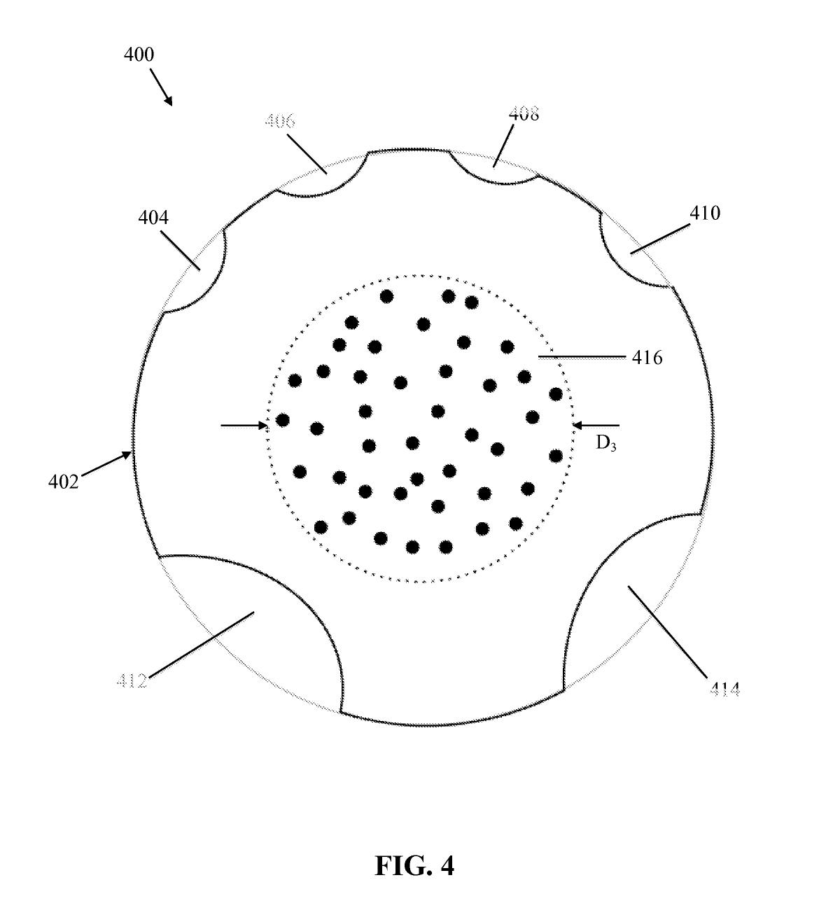

FIG. 4 illustrates one embodiment of a device 400 that includes a base 402 having four spaced indentations 404, 406, 408, 410 on one side thereof and two spaced indentations 412, 414 on an opposite side thereof. The indentations 404, 406, 408, 410 can be configured to accommodate a user's four fingers and the two spaced indentations 412, 414 can be configured to accommodate a user's thenar and hypothenar eminences (i.e., the muscular masses that extend from the base of the palm to the thumb and little finger, respectively). By providing the indentations 404-414, a user can more securely grasp the base 402 by wrapping their fingers and thumb around the device as they press their palm into it. Of course, any combination of these indentations can be also be provided, ranging from a single indentation to a repeating series of indentations extending around the circumference of the base to allow a user to securely grasp the base 402 from any orientation.

Alternatively, or in addition to features such as the indentations 404-414, the base 402 can also include a second textured non-slip surface 416 formed thereon and configured to prevent sliding motion between the device 400 and a user's palm during use. The second textured non-slip surface 416 can be the same as, or substantially similar to, the textured non-slip surface 110 discussed above. Further, the size of the textured non-slip surface 416 can be equal to, or substantially similar to, the size of the massage head of the device. For example, in some embodiments, a diameter D₃ of the second textured non-slip surface 416 can be equal to, or substantially the same as, the diameter D₂ of the massage head 106 shown in FIG. 1.

In some cases, it can be desirable to attach or couple a massage device to a surface of a structure, such as a wall, etc. to allow a user to move against the device rather than press the device into their body using their hands. Accordingly, in some embodiments the base of a device can include one or more features configured to allow the device to be removably coupled to a surface of a structure such that a massage head of the device protrudes away from the surface.

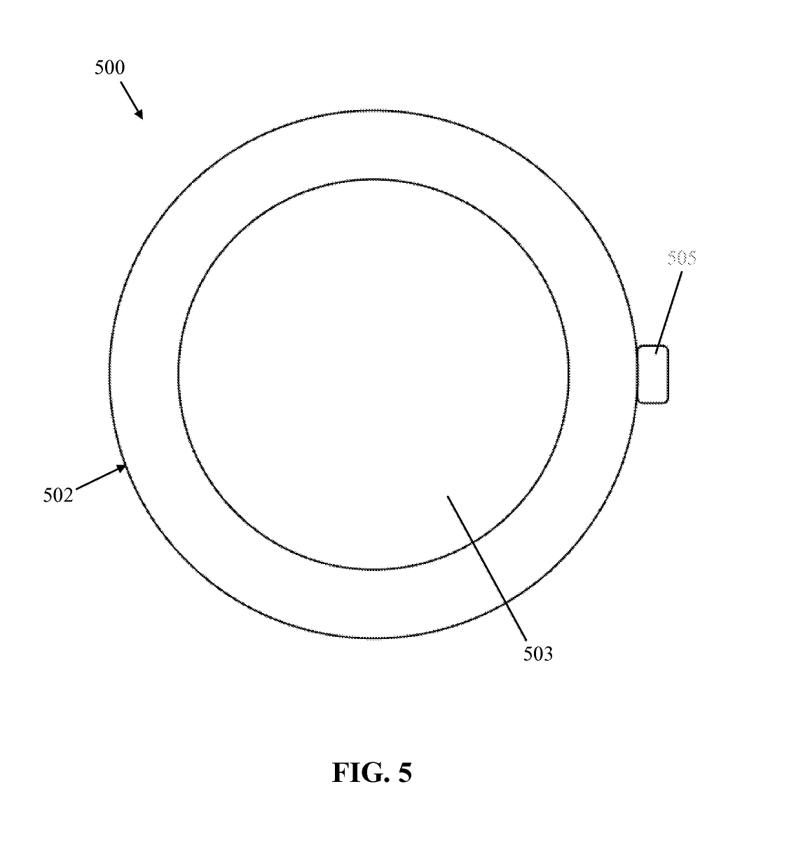

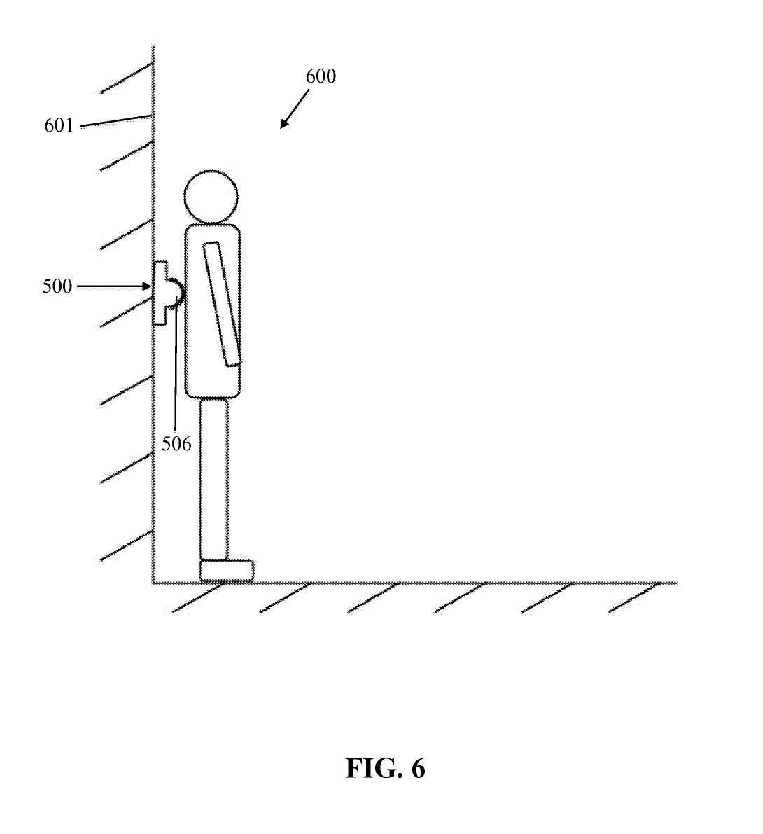

FIG. 5 illustrates one embodiment of a device 500 that includes a base 502 having a suction cup 503 formed therein and configured to allow the device 500 to be mounted on a surface with its massage head 506 (see FIG. 6) protruding from the surface. The illustrated embodiment shows one large suction-cup, but in other embodiments a plurality of smaller suction cups can be formed on the base 502. The base 502 can also include one or more tabs 505 or other features formed on an outer surface thereof that can aid a user in breaking the suction to remove the device 500 from a structure.

FIG. 6 illustrates the device 500 being used by a patient 600. As illustrated, the base 502 of the device 500 has been attached to a wall 601 using the suction cup 503. The patient 600 can then move against the massage head 506 that protrudes out from the surface of the wall 601. Using the device 500 in this manner can allow the patient 600 to reach portions of their body that they cannot normally reach with their arms (e.g., the back), as well as to apply greater amounts of pressure with ease. The selectively removable suction cup 503 can allow the user to repeatedly attach the device 500 to the wall 601 at different heights in order to target particular portions of the body (e.g., lower legs, upper legs, hips, lower and upper torso, etc.). The user can also repeatedly alternate between grasping the device 500 in their hand and attaching it to the wall 601. Accordingly, the base 502 of the device 500 can, in some embodiments, also include features that facilitate use by hand, such as the one or more indentations 404-414 or the second textured non-slip surface 416 shown in FIG. 4. In such embodiments, any of the indentations 404-414 can be positioned outside the suction cup 503, while the second textured non-slip surface 416 can be positioned on an inner portion of the suction cup 503. Alternatively, a series of smaller suction cups can be disposed around a circumference of the base 502 outside of the second textured non-slip surface.

The suction cup 503 described above is only one of a variety of mechanisms that can be incorporated into the base of a massage device to allow for removable attachment to a surface of a structure. Other exemplary mechanisms can include a tacky or adhesive surface, a hook and loop surface (e.g., Velcro®), magnets, and other known forms of selective/removable attachment/coupling.

To use the devices described above, as well as other embodiments of the present invention, a user can press the massage head of a massage device into a designated spot on their body (or on the body of another person) in a manner that does not allow for sliding of the massage head on the skin. Pressing the massage head in this manner can prevent blisters from forming on the skin through use of the device and can ensure that the device causes sliding motion in the deeper fascia layers that surround muscle below the skin surface. The forced sliding motion of the fascia over the muscle can undo or eliminate any adhesions formed in the immediate area of the massage head. Forcing sliding motion of the fascia over the muscle can produce a sensation of pain that can radiate to other regions adjacent to the spot where pressure is applied. These sensations, however, typically subside within a short period of time after the application of pressure (e.g., in a range of about 2 minutes to about 5 minutes).

In some embodiments, a method for tissue massage can include positioning a tissue massage device over a portion of a user's body such that a massage head of the device having a textured non-slip surface (e.g., massage head 106) contacts a user's skin. The method can also include applying pressure to the tissue massage device such that the massage head does not slide on the user's skin to cause sliding between subcutaneous fascia and muscle.

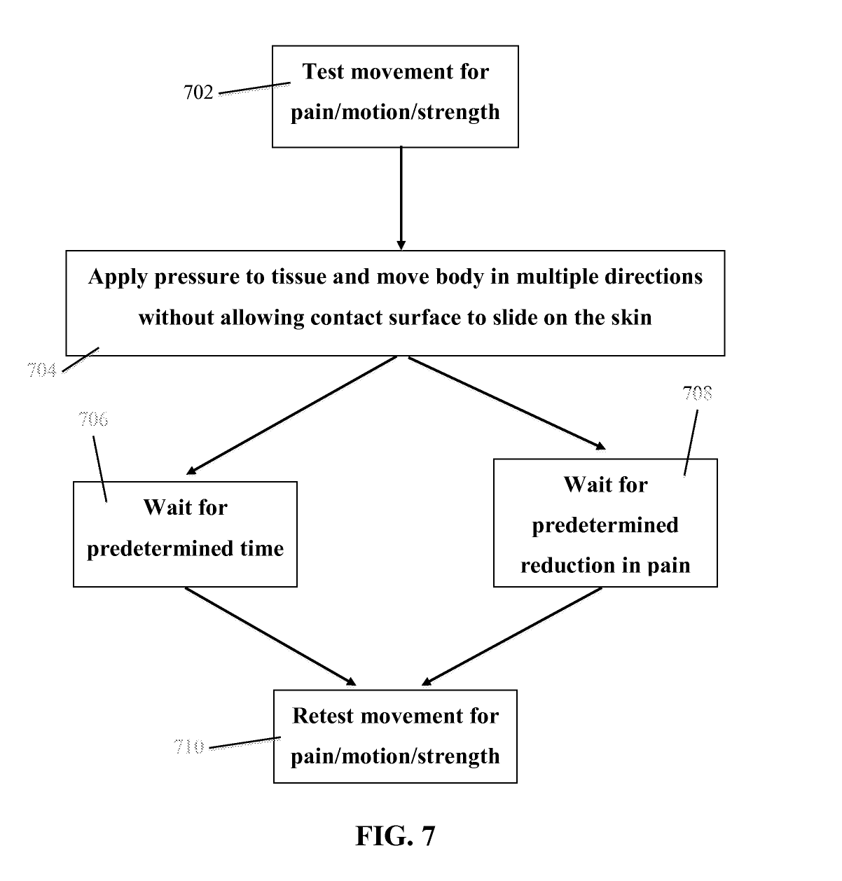

The portion of the user's body can be selected based on a number of different factors. For example, a portion of the body can be selected based on soreness, discomfort, or other sensations experienced by a user in particular areas of the body. In other embodiments, however, portions of the body can be selected based on their relation to particular movement dysfunctions observed in a user. FIG. 7, for example, illustrates one embodiment of a method for tissue massage that begins with testing a user for pain, strength, or range of motion with regard to a specific movement (e.g., testing range of motion of an elbow joint) (step 702).

The method can further include applying pressure to tissue at a particular point associated with dysfunction in elbow joint motion (step 704). The particular point associated with this movement dysfunction can be selected from a listing of over 150 neurologically dense points on the human body that are each associated with a particular movement dysfunction (ranging from large motor movements all the way to movements of fingers, toes, and eyes). This listing has been compiled by extensive cadaver research. Further information can be found in Stecco L., Fascial Manipulation for Musculoskeletal Pain, Piccin, 2004, which is incorporated by reference in its entirety above.

Pressure can be applied using, for example, any of the embodiments of a massage device described herein. For example, pressure can be applied by a user grasping a massage device in their hand and moving it in multiple directions against their body. Alternatively, if a massage device is coupled to a wall, floor, or other surface, a user can move their body in multiple directions against the device. Regardless, however, the device should be moved relative to the body without allowing a contact surface thereof to slide on the user's skin. Moving the body against the device in this manner causes subcutaneous sliding at the interface between muscle fibers and other tissue.

Pressure can be applied to the designated point for some period of time that can be predetermined, or can be based on a sensation of pain experienced by a user. For example, in some embodiments, pressure can be applied for a predetermined period of time (step 706). An exemplary period of time can be in a range of about 2 minutes to about 5 minutes. Alternatively, pressure can be applied until a sensation of pain experienced by a user subsides by at least a threshold amount (step 708). For example, in some embodiments pressure can be maintained until a user experiences or reports a reduction in pain of about 50%.

After the application of pressure using an embodiment of the devices described herein, the method can include retesting the movement associated with the particular spot where pressure was applied (e.g., retesting range of motion of the elbow joint) (step 710). Depending on the level of improvement measured objectively (e.g., range of motion, strength assessment, etc.) or subjectively (e.g., decrease in pain experienced or reported, etc.), the method can be repeated on the same spot or a user can test a new movement (e.g., hamstring strength) and apply pressure in a new location.

The use of a device according to the present invention in combination with a movement assessment process can produce improved movement patterns based on both objective and subjective assessment criteria. These improvements can prevent movement related injury and pain development, and can enhance performance. For example, there have been many studies showing that improved amplitude, strength, and speed of movement can decrease frequency of movement related injuries, such as anterior cruciate ligament (ACL) tears, ankle sprains, shoulder injuries, back injuries, and neck injuries. The devices and methods described herein can provide evidence based application of fascia tissue mobilization that can be correlated to actual movement (e.g., through pre- and post-treatment movement testing). In addition, the methods and devices described herein can provide immediate results which, again, can be measured through both objective and subjective metrics. Moreover, the devices and methods described herein are portable, require no permanent installation, and can be applied in myriad fields, including personal and professional health care and fitness.

All papers and publications cited herein are hereby incorporated by reference in their entirety. One skilled in the art will appreciate further features and advantages of the invention based on the above-described embodiments. Accordingly, the invention is not to be limited by what has been particularly shown and described, except as indicated by the appended claims.

What is claimed is:

1. A tissue massage device, comprising:
a base configured to be grasped in a user's hand such that a first surface at a proximal end of the device abuts against the user's palm; and
a massage head extending from a second surface of the base that is distal to the first surface, the massage head having a generally convex shape and including a textured non-slip surface formed on a distal portion thereof.

2. The tissue massage device of claim 1, wherein the first surface includes a suction cup configured to allow the device to be mounted on a surface with the massage head protruding from the surface.

3. The tissue massage device of claim 1, wherein the first surface includes a second textured non-slip surface formed thereon and configured to prevent slipping between the device and the user's palm.

4. The tissue massage device of claim 1, wherein the first surface includes at least one indentation formed therein and positioned to accommodate a portion of the user's hand.

5. The tissue massage device of claim 4, wherein the at least one indentation includes four indentations of equal size configured to receive the user's fingers.

6. The tissue massage device of claim 4, wherein the at least one indentation includes two opposed indentations configured to receive the user's thenar and hypothenar eminences.

7. The tissue massage device of claim 1, wherein a weight of the tissue massage device is in a range of about 0.4 kg to about 1 kg.

8. The tissue massage device of claim 1, wherein the base and the massage head are formed from any of silicone and foam rubber.

9. The tissue massage device of claim 1, wherein the textured non-slip surface of the massage head includes one or more surface features protruding from a surface of the massage head.

10. The tissue massage device of claim 1, wherein a diameter of the massage head is configured to match a size of a neurologically dense portion of a patient's body.

11. The tissue massage device of claim 10, wherein the diameter of the massage head is in a range of about 40 mm to about 70 mm.

12. A method for tissue massage, comprising:
positioning a tissue massage device over a portion of a user's body such that a massage head of the device having a textured non-slip surface contacts the user's skin; and
applying pressure to the tissue massage device such that the massage head does not slide on the user's skin to cause sliding between subcutaneous fascia and muscle.

13. The method of claim 12, wherein positioning the tissue massage device includes removably mounting the tissue massage device to a surface and positioning the user's body relative to the device.

14. The method of claim 13, wherein applying pressure to the tissue massage device is done by the user pressing their body into the device.

15. The method of claim 12, wherein positioning the tissue massage device is done by the user grasping the tissue massage device in their hand.

16. The method of claim 15, wherein applying pressure to the tissue massage device is done by the user's hand.

17. The method of claim 12, further comprising:
testing a movement of the user's body for any of pain, range of motion, and strength prior to positioning the tissue massage device; and
re-testing the movement of the user's body after applying pressure to the tissue massage device.

18. The method of claim 12, wherein pressure is applied to the tissue massage device for a predetermined time.

19. The method of claim 12, wherein pressure is applied to the tissue massage device until a user experiences a predetermined reduction in pain.

20. A method for tissue massage, comprising:
positioning a tissue massage device having a generally convex massage head extending from a base configured to be grasped in a user's hand over a portion of a user's body such that a textured non-slip surface on a distal end portion of the massage head contacts the user's skin; and
applying pressure to the base of the tissue massage device to drive the massage head into tissue such that the massage head does not slide on the user's skin and sliding motion is induced in subcutaneous tissue.
